(19) United States
(12) Patent Application Publication
(10) Pub. No.: US 2010/0194664 A1
(43) Pub. Date: Aug. 5, 2010

(54) Antenna rod having an interior sheathed rod with a winding

(76) Inventor: Günter Blickle, Walddorfhäslach (DE)

Correspondence Address: KF ROSS PC, 5683 RIVERDALE AVENUE, SUITE 203 BOX 900, BRONX, NY, 10471-0900, US

(21) Appl. No.: 11/919,197

(22) PCT Filed: Apr. 25, 2006
(86) PCT No.: PCT/EP2006/003802

§ 371 Date: Oct. 12, 2009

(30) Foreign Application Priority Data
Apr. 26, 2005 (DE) 10 2005 019 249.1

(51) Int. Cl. H01Q 1/50; H01Q 1/12; B32B 37/10; B29C 63/10

(52) U.S. Cl. 343/888; 343/906; 156/187; 156/84

(57) ABSTRACT

The invention relates to a rod-shaped antenna (1) having a distal threaded connecting piece (6) for screwing the antenna (1) into an antenna base, the antenna (1) comprising a rod (2) that can be fixed in the threaded connecting piece (6). A wire winding (4) for transmitting and receiving high-frequency signals is disposed on top of the rod. According to the invention, the rod (2) is configured as an interior rod with an interior sheathing (3) applied to it. The wire winding (4) is disposed on the interior sheathing (3) and is electrically contacted to the threaded connecting piece (6). The threaded connecting piece (6) and the rod (2) with the interior sheathing (3) and the wire winding (4) applied thereto are at least partially enclosed by an outer shell (7).

The invention relates to an antenna, particularly for a vehicle, comprising a rod forming a rod antenna on which a wire winding is provided for transmitting and/or receiving high-frequency signals, according to the features of the preamble of claim 1, and to a method of making such an antenna according to the features of the preamble of claim 8.

Such antennas whose rod antennas (either short or long) screwed into an antenna base, are known in principle. While in practical applications they operate satisfactorily, they require improvement with respect to their production and mechanical properties during subsequent operation.

It is therefore the object of the invention to improve a rod antenna that can be screwed into an antenna base with respect to the production of the rod and the mechanical properties thereof during subsequent operation.

This object is achieved with the features of claims 1 and 8.

According to the invention, the rod is configured as an inner rod with inner sheathing provided thereon, the winding (hereinafter referred to as wire winding, however this shall not be interpreted as any limitation to this embodiment) being carried on the inner sheathing and in electrical contact with a threaded connector, both the threaded connector and the rod with its inner sheathing and the wire winding being surrounded at least partially by an outer sheathing.

This results in the following design with the corresponding features as well as embodiment possibilities:

The inner rod made of glass fibers or a material with comparable properties has excellent flexibility and stability against breakage as well as ideal restoring characteristics when bent. The rod is covered by a thermoplastic elastomer (TPE) or by a thermoplastic material with sufficient elastic properties. Materials of this type are available for purchase as a semi-finished product (for example from Polystal). Alternatively, the use of a separate sleeve made of TPE, rubber or the like is conceivable, into which the rod is inserted. The winding is mounted (copper wire, strip, copper-coated steel or the like), if necessary with different gradients on the sheathing, which has the necessary outside diameter. If bar stock is used, piece goods can be wound and then cut to length. If necessary, the winding can be fixed in place by different measures: shrinkable tubing, wrapping adhesive tape around or clamping at the ends. Additional possibilities include winding under specific tensile stress on the wire, causing the winding wire to imbed itself in the elastic sheathing and fix itself into place axially by the resulting positive fit. During winding, the wire is pressed by a roller into the sheathing to a defined depth, in which case it may be expedient to make the material easily deformable by local heating. During (prior to or after) winding, a thin paint or adhesive layer or the like is applied to the sheathing, the layer curing quickly and fixing the winding in place. The threaded connector comprises a sleeve in which the covered rod with the winding is inserted. Thereafter, the sleeve is compressed, axially fixing the rod in place in the sleeve. Electric contact between the winding and connector can be established without soldering since the winding during compression is clamped between the sleeve and the elastic sheathing. To ensure that the winding wire does not tear or get sheared off during compression, a smooth transition (radius) is provided in the inside sleeve diameter in the insertion region of the rod or the winding. To increase the required pull-out resistance, local or peripheral depressions may be impressed into the press-fit region. The sleeve is configured at least long enough to provide the covered rod with a secure hold. The length of the rod can be dimensioned such that with this part of the rod antenna, if possible, the high-frequency radio function of the rod can be implemented. A short coil (which is known from conventional rods) may be necessary for AM/FM and telephone between the sleeve and winding. Ideally, a particularly tight winding in the region shortly behind the sleeve can fulfill this function, without requiring an additional part including assembly, soldering and the like. After pressing, the unit comprising the threaded connector and covered, wound rod is inserted into an extrusion-coating tool and coated with santoprene or another suitable elastic thermoplastic material, the desired outer shape being thus produced and the sleeve, rod and winding being protected from mechanical damage, moisture and influences from the environment. In the pressing region, the sleeve may be formed to a non-circular (for example hexagonal) cross-section. This prevents the over-molding from twisting relative to the sleeve when screwing the rod into the antenna base. To the same end, the region between the threaded pin and sleeve is given a non-circular (for example hexagonal) shape. In addition, axial and/or tangential grooves may be provided to secure the over-molding against torsion. On the threaded connector, a predetermined breaking point may be provided (for example, at the outer end of the threaded pin or at the start of the sleeve), so that the rod breaks off near the antenna base in the event of excess mechanical stress. In this way, damage to the antenna base and particularly injury to people during an accident by the rigid sleeve of the threaded connector are prevented. The threaded connector is made of metal (for example brass) and, as an alternative to conventional machining, is produced economically by forming (impact extrusion), whereby in particular the sleeve region can be produced with minimal material. Grooves to prevent the over-molding from twisting and the thread (typically M5) can be integrally formed. Subsequent coating (for example nickel-plating) protects the part from corrosion.

In this way, the invention offers cost advantages (simple design, low number of components and assembly steps), production advantages (possibility of solderless manufacture) as well as advantages with respect to design (possibility of a single variant with standard integrated telephone function) and mechanical properties (bending rigidity can be defined by the thickness and material of the rod and sheathing, excellent restoring characteristics after bending).

Illustrated embodiments of the antenna according to the invention are described hereinafter and explained with reference to the figures, without limiting the invention.

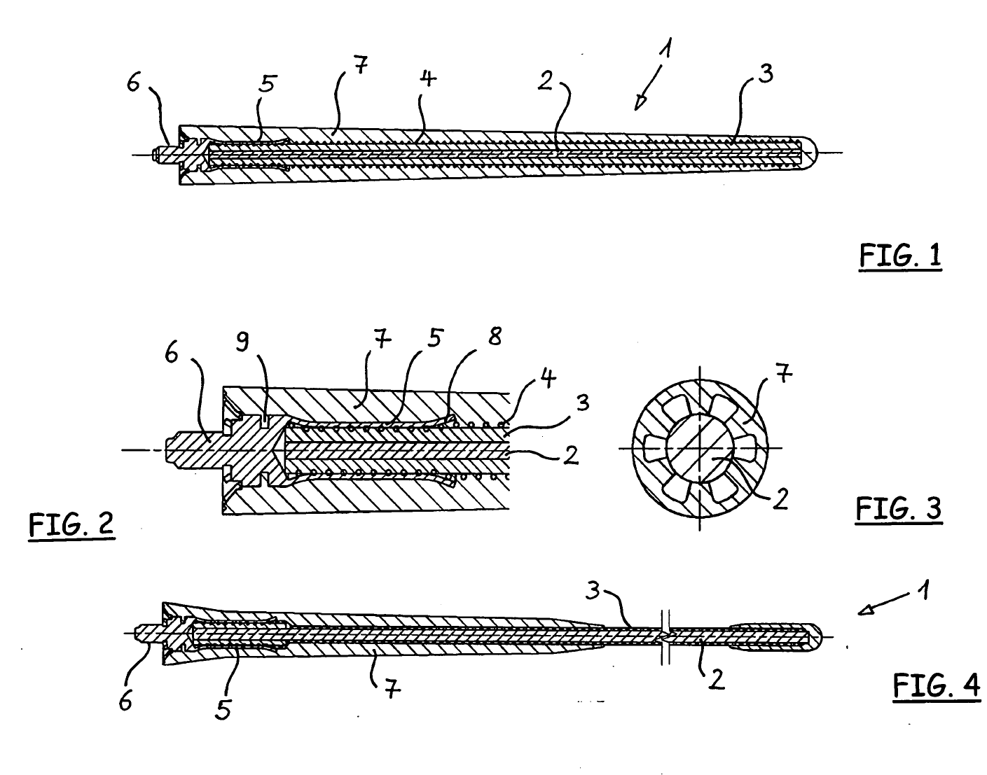

FIGS. 1 and 3, to the extent shown in detail, illustrate an antenna 1 comprising an inner rod 2 that is surrounded by a first sheathing (inner sheathing 3). Provided thereon is a wire winding 4. The rod 2 prepared in this way is inserted into a sleeve 5, or alternatively into a bore of a threaded connector 6 and is fixed in place there, preferably by compressing the sleeve 5. Then, an outer sheathing 7 is provided thereon, which in this illustrated embodiment encloses the entire antenna 1 (with the exception of the thread at the lower end of the threaded connector 6 with which the antenna 1 is screwed into an unillustrated antenna base). To be able to insert the prepared rod 2 securely in the threaded connector 6, the sleeve 5 at the upper end thereof comprises a widened region 8 (FIG. 2). In addition, a predetermined fracture point 9 may be provided. A special profile for the inner sheathing 3 of the rod 2 with a reduced material cross-section (example see FIG. 3) instead of the inner sheathing with the full annular cross-section can further improve the flexibility of the unit comprising the rod 2 and inner sheathing 3. If the inner sheathing 3 is made as a separate part into which the rod 2 must be inserted, this type of shaping facilitates such a process. The material used for the sheathing is reduced.

The invention can also be applied to long rod antennas (FIG. 4). The outer and/or inner sheathing of the rod 2 can be limited to the lower end and can be implemented, for example, by a rubber sleeve that is fitted on. The winding is provided on the rod and rubber sleeve.

### LIST OF REFERENCE NUMERALS

1. Antenna
2. Inner rod
3. Inner sheathing
4. Wire winding
5. Sleeve
6. Threaded connector
7. Outer sheathing
8. Widened region
9. Predetermined breaking point

1. A rod-shaped antenna comprising a threaded connector at an end thereof for screwing the antenna into an antenna base, the antenna comprising a rod that can be fixed in placed in the threaded connector and a wire winding mounted outside it for transmitting or receiving high-frequency signals, the rod being configured as an inner rod with an inner sheathing provided thereon, the wire winding being mounted on the inner sheathing and in electrical contact with the threaded connector, both the threaded connector and the rod with the inner sheathing provided thereon as well as the wire winding being surrounded at least partially by an outer sheathing.

2. (canceled)

3. The antenna according to claim 1 wherein the inner sheathing is made of a thermoplastic elastomer or thermoplastic material with sufficient elastic properties.

4. The antenna according to claim 1 wherein the inner sheathing is configured as a separate sleeve that is made of TPE, rubber or the like, into which the rod is inserted.

5. The antenna according to claim 1 wherein the rod with the inner sheathing provided thereon and the wire winding is fixed in a sleeve of the threaded connector by compressing or soldering.

6. The antenna according to claim 6 wherein, after the compression operation, the sleeve has a non-circular cross section.

7. The antenna according to claim 5 wherein the sleeve has a seat comprising a widened region for the rod.

8. A method of making an antenna according to claim 1 wherein the rod is surrounded by a thermoplastic elastomer or by a thermoplastic material with sufficient elastic properties or is inserted in a separate sleeve made of TPE or rubber.

9. The method according to claim 8 wherein on the covered rod the wire winding, which is made of copper wire, strip, copper-coated steel or the like and in the necessary outside diameter, is applied with regions of different pitch.

10. The method according to claim 9 wherein the wire winding is fixed in place on the inner sheathing by shrinkable tubing, wrapping adhesive tape around it or clamping at the ends.

11. The method according to claim 9 wherein the wire winding is wound onto the inner sheathing under specific tensile stress, causing the winding wire to embed itself in the elastic inner sheathing and fixing the wire winding in place there axially by the resulting positive fit.

12. The method according to claim 9 wherein during winding the wire winding is roller-pressed into the inner sheathing to a defined depth, the material to this end being made easily deformable by local heating.

13. The method according to claims 8 wherein a thin paint or adhesive layer or the like is applied onto the inner sheathing before or during or after winding, the layer being cured and fixing the wire winding in place.

14. The method according to claim 8 wherein the covered rod with wire winding is inserted into the sleeve of the threaded connector and then the sleeve is compressed, axially fixing the rod in the sleeve and establishing electrical contact between the wire winding and the threaded connector.

15. The method according to claim 8 wherein after compression the threaded connector and the covered wound rod are set in a mold and over molded with a thermoplastic elastomer.

16. (canceled)

17. An antenna comprising:
a flexible fiberglass core rod;
an electrically conductive metal connector at an inner end of the core rod;
a deformable inner sheath surrounding at least an inner portion of the core rod;
a conductive wire coil wrapped around the inner sheath, imbedded therein, and in electrical contact with the metal connector; and
an insulating outer sheath surrounding and covering the coil, inner sheath and inner portion of the core rod.

18. The antenna defined in claim 17 wherein the fitting is unitarily formed with an outwardly open sleeve into which the core rod and an inner end of the wire coil is fitted, the inner sheath overlying and lying outside the sleeve.

19. The antenna defined in claim 17 wherein the connector is formed inward of the sleeve with a radially outwardly open groove forming a fracture point, whereby when bent beyond a predetermined limit the connector breaks at the fracture point.

20. The antenna defined in claim 17 wherein the sleeve has an outwardly flared outer end.

21. The antenna defined in claim 17 wherein the outer sheath is formed with radially inwardly open and longitudinally extending grooves.

22. The antenna defined in claim 17 wherein the outer sheath is formed of an elastically deformable thermoplastic synthetic resin and the core rod is elastically bendable.
